(19) United States
(12) Patent Application Publication
(10) Pub. No.: US 2013/0127849 A1
(43) Pub. Date: May 23, 2013

(54) Common Rendering Framework and Common Event Model for Video, 2D, and 3D Content

(71) Applicants: Sebastian Marketsmueller, San Francisco, CA (US); David A. Tristram, Santa Cruz, CA (US); Lee B. Thomason, Berkeley, CA (US)

(72) Inventors: Sebastian Marketsmueller, San Francisco, CA (US); David A. Tristram, Santa Cruz, CA (US); Lee B. Thomason, Berkeley, CA (US)

(21) Appl. No.: 13/116,835

(22) Filed: May 26, 2011

(51) Int. Cl. G06T 15/00

(52) U.S. Cl. 345/420

(57) ABSTRACT

A multimedia presentation may include 2D and 3D content integrated into a common rendering framework and common event model. The 2D and 3D content may be rendered based on a specification of one or more rendering effects to be applied to both the 2D and 3D content. In response to an event pertaining to the 2D and 3D content, an effect may be applied to the 2D and 3D content according to the common event model. Creation of the multimedia presentation may include receiving a specification of one or more rendering effects to be applied to the 2D and 3D content and may also include receiving a specification of one or more event effects to the 2D and 3D content.

### BACKGROUND

1. Technical Field

This disclosure relates generally to media playback, and more specifically, to 2D and 3D media playback.

2. Description of the Related Art

Media playback engines provide a way to combine, in one presentation, rich media elements such as images, audio, video, two-dimensional (2D) and three-dimensional (3D) vector art, and typography. Such media playback engines, however are limited in that the various content (e.g., 2D content, 3D content) is treated separately and is composited at display controller for display. These systems lack the ability for any rendering effects such as 2D processing elements (e.g., filters, event processing, etc.) to be applied to 3D content and likewise lack the ability for events to affect both 2D and 3D content.

### SUMMARY

This disclosure describes techniques and structures that facilitate a common rendering framework and common event model for 2D and 3D content. In one embodiment, a multimedia presentation that includes 2D and 3D content may be received, for example, by a multimedia player. The 2D and 3D content may be integrated into a common rendering framework and common event model. In various embodiments, the 2D and 3D content may be rendered based on a specification of one or more rendering effects to be applied to both the 2D and 3D content according to the common rendering framework. In response to an event pertaining to the 2D and 3D content, an effect may be applied to both the 2D and 3D content according to the common event model.

In various embodiments, 2D and 3D content may each be received, for example, by a developer tool, and the received 2D and 3D content may be integrated into a common rendering framework and common event model. Integrating the content into the common rendering framework and common event model may include receiving a specification of one or more rendering effects to be applied to the 2D and 3D content. It may also include receiving a specification of one or more event effects to the 2D and 3D content. A multimedia presentation may be created that includes the 2D and 3D content integrated into the common rendering framework and common event model.

### BRIEF DESCRIPTION OF THE DRAWINGS

FIG. 1 is a flowchart of using an integrated common rendering framework and common event model for media playback of 2D and 3D content, according to some embodiments.

FIG. 2 is a flowchart of integrating 2D and 3D content into a common rendering framework and common event model, according to some embodiments.

FIG. 3 illustrates a block diagram of one embodiment of a multimedia player configured to playback an integrated 2D and 3D content common rendering framework and common event model.

FIG. 4 illustrates a block diagram of one embodiment of a developer tool usable to integrate 2D and 3D content into a common rendering framework and common event model.

FIG. 5 illustrates an example computer system that may be used in embodiments.

While the disclosure is described herein by way of example for several embodiments and illustrative drawings, those skilled in the art will recognize that the disclosure is not limited to the embodiments or drawings described. It should be understood, that the drawings and detailed description thereto are not intended to limit the disclosure to the particular form disclosed, but on the contrary, the intention is to cover all modifications, equivalents and alternatives falling within the spirit and scope of the present disclosure. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

Digital image editing applications including developer tools, executed on a computing device, may be used to manipulate, enhance, transform, create and render images, graphics, and videos, such as vector graphics (2D), 3D graphics, and video. Digital image editing applications may be used to render, modify, and edit such objects, according to various embodiments described herein, and may use an application programming interface (API) such as OpenGL, DirectX, or Direct3D. In some embodiments, APIs may be GPU-programmable and shader-based.

Various embodiments of methods and apparatus for rendering and applying event effects to 2D and 3D content that are integrated into a common rendering framework and common event model, as well as for integrating 2D and 3D content into a common rendering framework and common event model are described. Some embodiments may include a means for rendering, applying event effects, and integrating content. For example, one or more rendering modules may receive 2D and 3D content as input and render the 2D and 3D content based on a specification of one or more rendering effects according to the common rendering framework. An event interaction module may apply an effect to 2D and 3D content according to the common event model. In other embodiments, one or more integration modules may integrate 2D and 3D content into a common rendering framework and common event model. The rendering, event interaction, and integration modules may, in some embodiments, be implemented by program instructions stored in a computer-readable storage medium and executable by one or more processors (e.g., one or more CPUs or GPUs) of a computing apparatus. The computer-readable storage medium may store program instructions executable by the one or more processors to cause the computing apparatus to perform rendering and applying effects to 2D and 3D content that are part of an integrated into a common rendering framework and common event model, as well as for integrating 2D and 3D content into a common rendering framework and common event model, as described herein. Other embodiments of the rendering, event interaction, and integration modules may be at least partially implemented by hardware circuitry and/or firmware stored, for example, in a non-volatile memory.

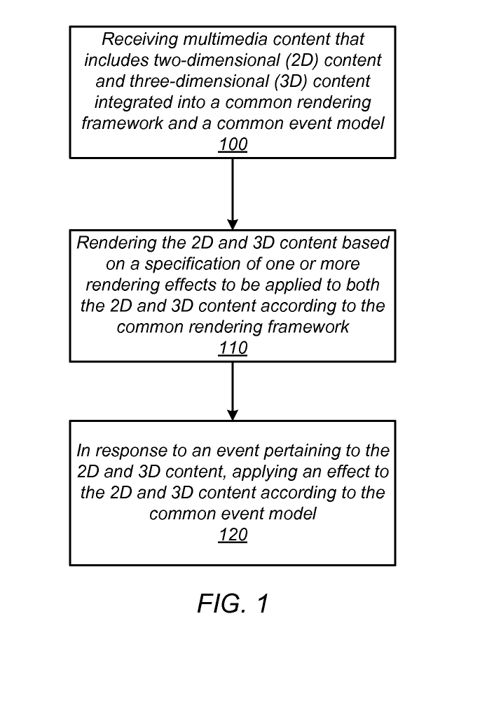

Turning now to FIG. 1, one embodiment for using an integrated common rendering framework and common event model for media playback of 2D and 3D content is shown. While the blocks are shown in a particular order for ease of understanding, other orders may be used. In some embodiments, the method of FIG. 1 may include additional (or fewer) blocks than shown. Blocks 100-120 may be performed automatically or may receive user input.

As indicated at 100, multimedia content that is integrated into a common rendering framework and common event model may be received. Multimedia content may be cross-platform in that the content may be platform independent and may not require any specific hardware or protocol to present the content. Cross-platform multimedia content may include 2D content (e.g., 2D graphics components or objects) and 3D content (e.g., 3D graphics components or objects). 2D content may include regular vector graphics, bitmap graphics (e.g., RGB pixel data), etc. 3D content may include accelerated or unaccelerated 3D graphics. In some embodiments, video content may also be received and integrated into the common rendering framework and common event model. Video may include hardware accelerated or hardware decoded video. In one embodiment, video content may be encoded using an accelerated codec (e.g., H.264). The multimedia content (e.g., animation, video, video game, etc.) may be received by a multimedia player configured to play the multimedia content. In some embodiments, the multimedia player, which may be executed on a CPU of a computing device, may perform blocks 100-120 of the method of FIG. 1. Common rendering framework is used herein to describe a rendering framework in which various content types are capable of being rendered, including rendering effects, within the same, single rendering framework. For example, in a common rendering framework, 2D and 3D content may be rendered and have rendering effects applied before final compositing. Similarly, common event model is used herein to describe an event model in which various content types are capable of responding to events within the same event model. As an example, a user viewing the multimedia content may provide an input to a multimedia player playing the multimedia content to create an event or the player itself may generate an event that pertains to both the 2D and 3D content, and an effect may be applied to both the 2D and 3D content in response to the event.

At 110, the 2D and 3D content may be rendered based on a specification of one or more rendering effects to be applied to both the 2D and 3D content according to the common rendering framework. Rendering effects may also be referred to as software composition. Rendering effects, such as blending, filtering, rotating, etc., may be performed on 2D graphics content and 3D graphics content in software on a CPU, such as a CPU executing the multimedia player. Such rendering effects may be applied according to the common rendering framework. However, any independently rendered layers (e.g., the content was rendered by a separate hardware resource other than the CPU executing the multimedia player) may be excluded from such operations. In some embodiments, though, some content (e.g., video) may be rendered independently using hardware resources separate from the CPU and those rendered components (e.g., video components) may be read into CPU memory to perform software composition operations. As another example, the 3D content may be rendered by a GPU and read-back to the CPU for rendering effects to be applied. Thus, in some embodiments, read-back (e.g., sending data from the GPU or other hardware to the central processing unit (CPU)) may facilitate independently rendered components' participation in the common rendering framework and common event model.

The 3D graphics layer may be rendered using dedicated hardware, such as a 3D graphics card or GPU, or in software on a CPU. In embodiments not using a CPU, read-back may be necessary before applying any rendering effects. For example, the resulting bitmap from rendering may be copied into the memory of the media player on a CPU to apply the rendering effects. In some embodiments, the 3D graphics content may be driven dynamically by CPU data at runtime, e.g., the 3D graphics content may not be pre-rendered. In one embodiment, one or more 3D graphics components may be rendered into one or more 3D graphics layers. Rendering may be performed using a very fast CPU rasterizer.

In some embodiments, one or more 2D graphics content or objects may be rendered into one or more 2D graphics layers, or may be rendered into a common layer with 3D graphics content. In some embodiments, 2D graphics content may appear above, below, or at the same layer as 3D graphics content. In some embodiments, the 2D graphics layer may be a software layer rendering from a CPU software rasterizer. In some embodiments, the 2D graphics layer may be driven dynamically by CPU data at runtime, but rendered on a different hardware resource (e.g., a GPU).

In some embodiments, the multimedia content may be represented as various layers in a display list. A display list may be used to describe how graphical elements are composited together (e.g., specify a rendering order). Thus, the display list may be used as a display graph or hierarchical scene graph. The display list may include a hierarchical representation of the contents of any 2D vector graphics, 3D vector graphics, or video. An object in the display list may include sub-objects that represent vector graphics, 3D graphics, or video. In some embodiments, the display list may also include a depth that may indicate the rendering/compositing/layering order in the display. As an example, the display list may indicate that a lowest layer be rendered first, a next lowest layer be rendered on top of the lowest layer, and so on until reaching a highest layer. Higher layers may obscure or partially obscure lower layers in the display list. Any processing (e.g., blending, filtering) may occur in a similar order. 3D graphics content may be rendered above or below 2D graphics content, and may appear above or below the 2D graphics content, as presented. In one embodiment, before or concurrent with rendering the 2D and 3D content, a data structure (e.g., the display list or hierarchical scene graph) may be generated. The data structure may include a plurality of non-graphical objects configured to direct the rendering. The non-graphical objects may carry the state associated with the graphics pipeline. They may manage geometry, coordinates, vertex data (e.g., VertexBuffers, IndexBuffers, Textures, and shader Programs), for example. In one embodiment, another data structure (e.g., a peer data structure) may also be generated. The peer data structure may include a plurality of graphical objects and may be hierarchical (e.g., a tree). The peer data structure may be an isomorphic representation of the data structure used to draw the elements. In various embodiments, the 2D and 3D content may be rendered into the plurality of graphical objects of the peer data structure. The plurality of graphical objects may define a 3D render area and may be leaf nodes in the display hierarchy.

As one example, the plurality of non-graphical objects of the display list may direct the rendering of the 2D and 3D content into the plurality of graphical objects of the peer data structure. The rendered content, in the form of the plurality of display objects, may be provided for final compositing for display. In some embodiments, each of the plurality of non-graphical objects of the data structure may be associated with a corresponding one of the plurality of graphical objects of the peer data structure without being associated with other graphical objects. In other embodiments, one of the plurality of non-graphical objects may be associated with multiple graphical objects of the peer data structure. Thus, there may not necessarily be a one-to-one correspondence between non-graphical and graphical objects. As such, multiple views may be effected on to a given set of vertices. In one embodiment, like any other display object, the plurality of graphical objects can be transformed arbitrarily, including through two-and-a-half-D transforms used to draw postcards in space. The graphical objects can have 2D filters applied to their rendered appearance, to add glow or drop shadows, for example.

In one embodiment, the graphical objects may be rendered using a platform graphics interface, e.g., OpenGL, Direct3D, etc., and the resulting bitmap may be copied into the multimedia player's memory for compositing as any other drawable display object. In other embodiments, the copy to the player's memory may be avoided by taking advantage of the GPU to render some or all of the content. In such embodiments, those content elements may be rendered using the platform graphics interface and the resulting bitmaps may also be composited there.

In one embodiment, a script (e.g., ActionScript code) may generate both the 3D model (e.g., hierarchical scene graph) and the peer data structure. Generation may occur inside a scripting language (e.g., ActionScript) via an application programming interface (API). At a lower level, the multimedia player may offer an API for creating both the 2D and 3D objects in a tree and may simultaneously enable them for inputs and rendering.

As illustrated at 120, an effect may be applied to the 2D and 3D content according to the common event model in response to an event pertaining to the 2D and 3D content. The multimedia player may support interaction from a user and other events for the presentation. In one embodiment, an integrated 2D and 3D execution environment may be used to control the content. The environment may be a scripting environment that receives input and executes a script (e.g., an ActionScript script) to perform an action to the 2D and 3D content. Accordingly, the various content components may each participate in the common event model of the player. An event may be attached to one or more objects of the 2D and/or 3D content that may have elements and corresponding objects in the action script of the programming environment. The common event model may dispatch to the respond to the event. Input may be received by the integrated execution environment to modify elements (e.g. size, location, etc.) of 2D and/or 3D objects. Both 2D and 3D graphics objects may have all the modification and composition operations applied to them according to the common event model.

In one embodiment, the script may also take advantage of the common event model of the multimedia player to allow for interaction with and between the various 2D and 3D content objects, according to some embodiments. Both 2D and 3D content objects may fully participate in the event model as well as take part in various software composition (e.g., filtering, blending with other layers, rotating, etc.). Additionally, both 2D and 3D content may take part in sizing and positioning operations as well as dispatch to respond to events. Thus, 2D and 3D objects may take part in any script operations. The script may attach events to various content objects, which may facilitate an overall interactive event model for the system. In one embodiment, the graphical objects can receive and emit events to process or react to user actions. Picked 3D graphical objects within the 3D view can trigger the generation of flash events.

As an example, events may include a variety of user inputs or events generated by the script. User inputs may include mouse clicks, keyboard inputs, touch screen inputs, etc. Generated events may include time-based events, collision detection, etc. Applying an effect to the 2D and 3D content according to the common event model may make use of the data structures discussed at block 120 of FIG. 1. In one embodiment, an effect may be mapped from one or more of the plurality of graphical objects in the peer data structure to a corresponding at least one of the plurality of non-graphical objects in the data structure (e.g., display list, hierarchical scene graph). The corresponding non-graphical object(s) may be updated in the data structure based on the effect. The 2D and 3D content may be rendered again to update the plurality of graphical objects based on the updated corresponding non-graphical objects(s). For instance, consider a video game in which a 3D object (e.g., an airplane) crashes into a 2D object (e.g. a building). The crash may be in response to a user input, for example, by a user using a controller. The effect (e.g., pixel effects resulting from the crash) may be mapped from the graphical objects of the peer data structure, as seen on the display by the user, to the corresponding non-graphical objects in the display list. Those corresponding non-graphical objects of the display list may be updated based on the effect and the graphical objects of the peer data structure may be updated by rendering the 2D and 3D content again according to the updated display list. As a result, the user may see the effect applied to both the 2D and 3D content according to the common event model. Similar examples may include interactions between 2D and 3D content based on a timer event or collision detection within the script running the video game.

In some embodiments, events may affect content other than 2D and 3D content, such as video or audio, as well. Consider any of the following example events: an event triggered by reaching a certain frame or timestamp in the video, an event triggered by the presence of a certain object in the video, or an event triggered by certain terms in the closed caption. In response to the event, video content may react by changing the playhead position (cueing to a different point in the video), changing playback speed, starting or stopping playback, changing audio or video tracks, showing or hiding segment objects or layers in the video, or turning captioning on and off, among other reactions.

In one embodiment, content-generated events may affect content other than 2D and 3D content (e.g., audio, video, etc.). For instance, a collision in 3D may trigger playback of a sound, or timers may trigger animations and transitions. Content-generated events may include generalized metrics. As an example, an overall number of pixels that exceed a brightness threshold may trigger an action, which may be useful in testing.

In various embodiments, the content may be composited for display. Compositing may be performed in software on a hardware resource (e.g., CPU) executing the player while in other embodiments, compositing may be performed by a separate hardware resource (e.g., display controller, GPU, etc.). For instance, in one embodiment, a central processing unit (CPU) may execute the multimedia player while a graphics processing unit (GPU) or display controller may perform the compositing. Compositing for display may include compositing the layers in an order from the display list or hierarchical scene graph. For example, in one embodiment, 3D graphics layer, 2D graphics layer, and another 3D graphics layer may be composited from bottom to top, in that order. Composition may be performed, in one embodiment, by a display controller. The display controller may be a dedicated piece of hardware for performing composition of the content layers. Compositing may be performed with alpha blending from the bottom to the top layer so that the layers may interact. In some embodiments, the display controller may include one or more buffers and other pieces of hardware that perform the blending. In some embodiments, the blending may be performed as specified via the multimedia player's API. The various layers may be updated asynchronously or synchronously.

By using an integrated common rendering framework and common event model, 3D content may participate fully within the framework and model, including layering, composition, and event propagation. This may allow for 3D content to appear above or below 2D content, have filters applied, and interact with the user and dispatch events.

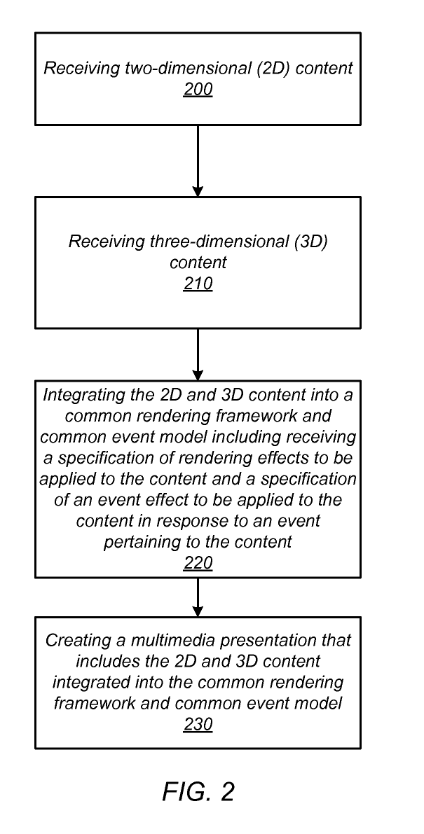

Turning now to FIG. 2, one embodiment for integrating 2D and 3D content into a common rendering framework and common event model is shown. While the blocks are shown in a particular order for ease of understanding, other orders may be used. In some embodiments, the method of FIG. 2 may include additional (or fewer) blocks than shown. Blocks 200-230 may be performed automatically or may receive user input.

As shown at 200, 2D content may be received. The 2D content may be received, for example, by a developer tool, which may be executed by a CPU implemented on a computing device. Similarly at 210, 3D content may be received, for example, by the developer tool. The various 2D and 3D content is similar to the 2D and 3D content described at FIG. 1.

As illustrated at 220, the 2D and 3D content may be integrated into a common rendering framework and common event model. In one embodiment, a specification of rendering effects to be applied to the 2D and 3D content may be received. The specification of one or more rendering effects to be applied to both the 2D and 3D content may allow for the 2D and 3D content to be rendered into a single data structure (e.g., a peer data structure of a display list) during playback of a multimedia presentation that includes the rendering effects according to the common rendering framework. The common rendering framework and common event model may enable, during playback, a data structure that includes a plurality of non-graphical objects to direct rendering of the 2D and 3D content according to the specified rendering effects into another data structure (e.g., peer data structure) that includes a plurality of graphical objects. The data structure, peer data structure, and respective objects may be similar to those described at FIG. 1. In one embodiment, once the data structure and peer data structure have been defined, the programmer using the developer tool may call context3D.DrawTriangles( ) to indicate that stored vertices are to be processed by the graphics pipeline. Like any other display object, the display object may be capable of being transformed arbitrarily, including through two-and-a-half-D transforms used to draw postcards in space. The display objects may also be capable of having 2D filters applied to its rendered appearance, for example, to add glow or drop shadows.

In one embodiment, a specification of one or more event effects to be applied to the 2D and 3D content may be received. The specification of one or more event effects to the 2D and 3D content may allow for applying the one or more event effects to the 2D and 3D content in response to an event pertaining to the 2D and 3D content received during playback of the multimedia presentation. In various embodiments, applying the one or more event effects during playback may include mapping the one or more event effects from one or more of the plurality of graphical objects in the peer data structure to a corresponding one or more of the plurality of non-graphical objects in the display list. Applying the one or more event effects may further include updating the corresponding non-graphical object in the display list based on the one or more event effects. The 2D and 3D content may be rendered again to update the plurality of graphical objects based on the updated display list. Such application of the one or more event effects may occur in the manner described at FIG. 1. The display objects can receive and emit events to process or react to user actions. Picked 3D items within the 3D view can trigger the generation of flash events.

As shown at 230, a multimedia presentation that includes the 2D and 3D content integrated into the common rendering framework and common event model may be created. The integrated 2D and 3D content, including the received specification of rendering effects and received specification of event effects, may be packaged as a multimedia presentation. For example, the created multimedia presentation may be a video, video game, or animation and may be played back in a multimedia player.

Creating a multimedia presentation that integrates 2D and 3D content into a common rendering framework and common event model may allow for an expressive 2D user experience development environment with a high-performance, high-fidelity 3D rendering engine. High-resolution, flexible typography and easily programmed articulated 2D vector elements can be seamlessly joined with complex 3D art including support for sophisticated shader programming.

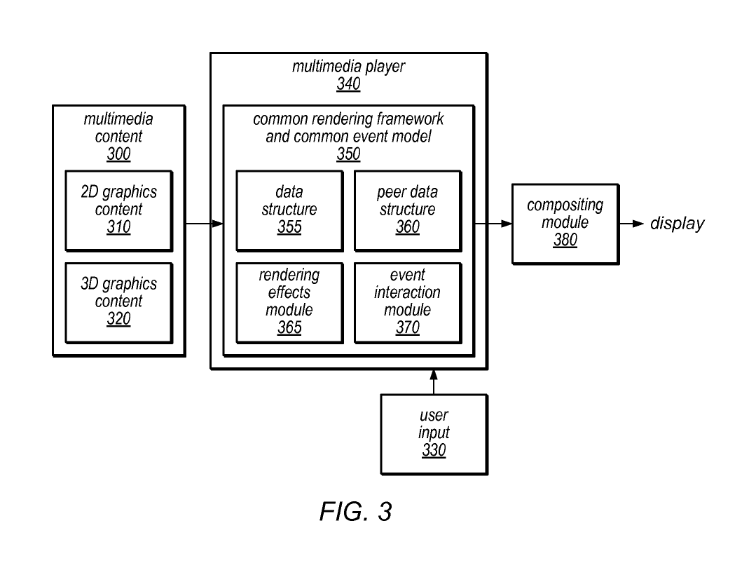

FIG. 3 illustrates a block diagram of one embodiment of a multimedia player configured to playback an integrated 2D and 3D content common rendering framework and common event model. FIG. 3 includes a multimedia player 340, which may be implemented on a CPU, that receives multimedia content 300 including 2D graphics content 310 and 3D graphics content 320. Multimedia content 300 may be a video, video game, animation, etc. User input 330 may be received, which may include input receiving via a mouse, touch screen, controller, stylus, among other user devices. Multimedia player 340 may include a common rendering framework and common event model 350 configured to render the 2D and 3D content according to the common rendering framework and to applying an effect to the 2D and 3D content according to the common event model in response to an event pertaining to the 2D and 3D content. Common rendering framework and common event model 350 may include data structure 355, peer data structure 360, rendering effects module 365, and event interaction module 370. Data structure 355 may be a display list or hierarchical scene graph. It may be generated in response to receiving the multimedia content, or may be pre-generated. Peer data structure 360 may be generated by multimedia player 340 or may be pre-generated as well. Peer data structure 360 may include graphical objects that correspond to non-graphical objects of the display list. Rendering effects module 365 may apply rendering effects (e.g., software composition, blending, filtering, rotating, etc.) according to the common rendering framework. Event interaction module 370 may apply an effect to the 2D and 3D content according to the common event model in response to an event pertaining to the 2D and 3D content. Events may include received or emitted events, such as user inputs, timed events, collision detection, among others. Compositing module 380 may composite the 2D and 3D content for display. Compositing module 380 may be implemented on the same hardware executing the multimedia player, or may be implemented in different hardware (e.g., GPU, video decoder, display controller, etc.).

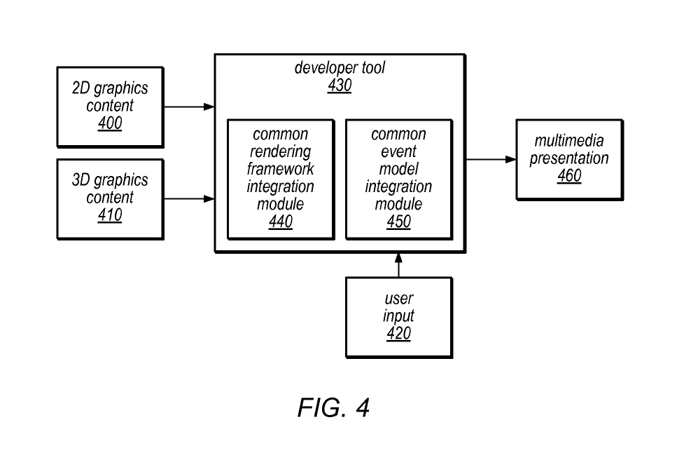

FIG. 4 illustrates a block diagram of one embodiment of a developer tool usable to integrate 2D and 3D content into a common rendering framework and common event model. FIG. 4 includes a developer tool 430, which may be implemented on a CPU. Developer tool 430 may receive 2D graphics content 400 and 3D graphics content 410. In the illustrated embodiment, developer tool 430 may include one or more integration modules 450 and 460 (e.g., a common rendering framework integration module 450 and common event model integration module 460). Common rendering framework integration module 450 may integrate the 2D and 3D content into a common rendering framework based on a specification of one or more rendering effects to be applied to both the 2D and 3D content. Common event model integration module 460 may integrate the 2D and 3D content into a common event model based on a specification of one or more event effects to the 2D and 3D content. The received specification of one or more rendering effects and/or one or more event effects may be received by user input 420 or by some other auto-generated input. As shown in FIG. 4, developer tool 430 may create a multimedia presentation 460, which may be a video, video game, animation, or other multimedia presentation type.

### Example System

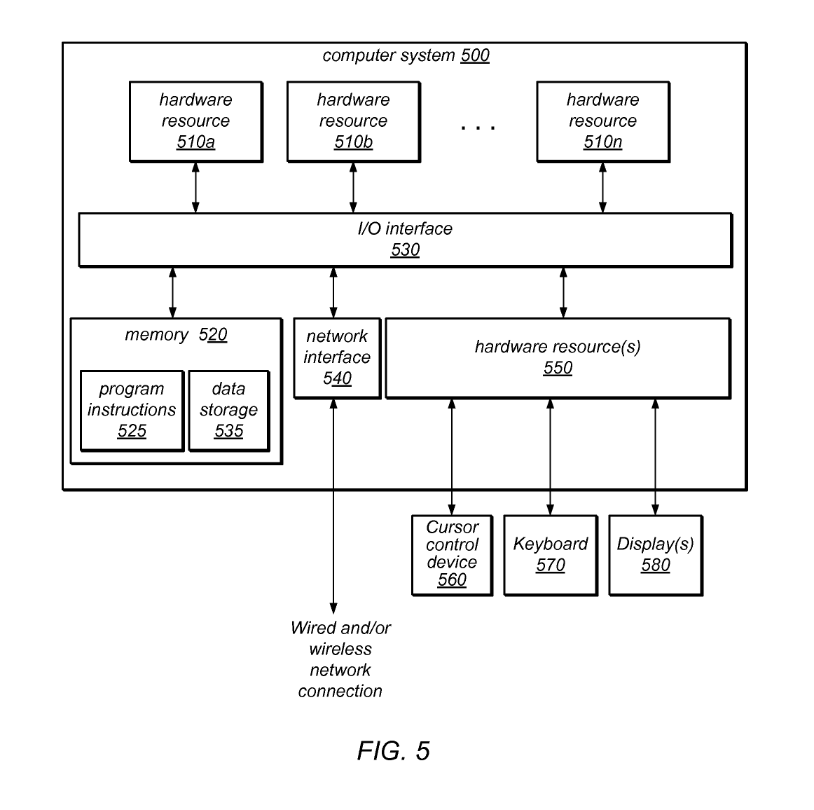

FIG. 5 illustrates a device by which a multimedia player may use an integrated common rendering framework and common event model for media playback of 2D and 3D content according to the various rendering and effects applying techniques as described herein. FIG. 5 further illustrates a device by which a developer tool may integrate 2D and 3D content into a common rendering framework and common event model according to the various integration techniques as described herein. The device may interact with various other devices. One such device is a computer system 500, such as illustrated by FIG. 5. In different embodiments, the device may be any of various types of devices, including, but not limited to, a personal computer system, desktop computer, laptop, notebook, or netbook computer, mainframe computer system, handheld computer, workstation, network computer, a camera, a set top box, a mobile device, personal digital assistant, smart phone, a consumer device, video game console, handheld video game device, application server, storage device, a peripheral device such as a switch, modem, router, or in general any type of computing or electronic device.

In the illustrated embodiment, computer system 500 includes one or more hardware resources 510 and 550, at least some of which may be coupled to a system memory 520 via an input/output (I/O) interface 530. Hardware resources 510 and 550 may include one or more processors, such as CPUs and/or GPUs, one or more video decoders, and/or other rendering or compositing hardware. Computer system 500 further includes a network interface 540 coupled to I/O interface 530, and one or more input/output devices, such as cursor control device 560, keyboard 570, and display(s) 580. In some embodiments, it is contemplated that embodiments may be implemented using a single instance of computer system 500, while in other embodiments multiple such systems, or multiple nodes making up computer system 500, may be configured to host different portions or instances of embodiments. For example, in one embodiment some elements may be implemented via one or more nodes of computer system 500 that are distinct from those nodes implementing other elements.

In various embodiments, computer system 500 may be a uniprocessor system including one processor, or a multiprocessor system including several processors (e.g., two, four, eight, or another suitable number). Processors may be any suitable processor capable of executing instructions. For example, in various embodiments, processors may be general-purpose or embedded processors implementing any of a variety of instruction set architectures (ISAs), such as the x86, PowerPC, SPARC, or MIPS ISAs, or any other suitable ISA. In multiprocessor systems, each of processors may commonly, but not necessarily, implement the same ISA.

In some embodiments, at least one processor may be a GPU. A GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more APIs that permit programmers to invoke the functionality of the GPU(s). Suitable GPUs may be commercially available from vendors such as NVIDIA Corporation, ATI Technologies (AMD), and others.

GPUs, such as one or more of hardware resources 550 may be implemented in a number of different physical forms. For example, GPUs may take the form of a dedicated graphics card, an integrated graphics solution and/or a hybrid solution. The dedicated graphics card may be a 3D graphics card. A GPU may interface with the motherboard by means of an expansion slot such as PCI Express Graphics or Accelerated Graphics Port (AGP) and thus may be replaced or upgraded with relative ease, assuming the motherboard is capable of supporting the upgrade. However, a dedicated GPU is not necessarily removable, nor does it necessarily interface the motherboard in a standard fashion. The term “dedicated” refers to the fact that hardware graphics solution may have RAM that is dedicated for graphics use, not to whether the graphics solution is removable or replaceable. Dedicated GPUs for portable computers may be interfaced through a non-standard and often proprietary slot due to size and weight constraints. Such ports may still be considered AGP or PCI express, even if they are not physically interchangeable with their counterparts.

Integrated graphics solutions, or shared graphics solutions are graphics processors that utilize a portion of a computer's system RAM rather than dedicated graphics memory. For instance, modern desktop motherboards normally include an integrated graphics solution and have expansion slots available to add a dedicated graphics card later. As a GPU may be extremely memory intensive, an integrated solution finds itself competing for the already slow system RAM with the CPU as the integrated solution has no dedicated video memory. For instance, system RAM may experience a bandwidth between 2 GB/s and 8 GB/s, while most dedicated GPUs enjoy from 15 GB/s to 30 GB/s of bandwidth. Hybrid solutions may also share memory with the system memory, but may have a smaller amount of memory on-board than discrete or dedicated graphics cards to make up for the high latency of system RAM. Data communicated between the graphics processing unit and the rest of the computer system 500 may travel through a graphics card slot or other interface, such as I/O interface 530 of FIG. 5.

Note that program instructions 525 may be configured to implement a graphics application (e.g., a multimedia player as described herein) as a stand-alone application, or as a module of another graphics application or graphics library, in various embodiments. For example, in one embodiment program instructions 525 may be configured to implement graphics applications such as painting, editing, publishing, photography, games, animation, and/or other applications, and may be configured to provide the functionality described herein. In another embodiment, program instructions 525 may be configured to implement the techniques described herein in one or more functions or modules provided by another graphics application executed on a GPU and/or other hardware resources 510 or 550 (e.g., a rendering module, an event interaction module, or an integration module). These modules may be executable on one or more of CPUs and/or GPUs to cause computer system 500 to provide the functionality described herein. The multimedia player may be implemented in various embodiments using any desired programming language, scripting language, or combination of programming languages and/or scripting languages, e.g., C, C++, C#, Java™, Perl, etc. For example, in one embodiment, the multimedia player may be JAVA based, while in another embodiments, it may be implemented using the C or C++ programming languages. In other embodiments, the multimedia player may be implemented using specific graphic languages specifically for developing programs executed by specialized graphics hardware, such as a GPU. In addition, the multimedia player take advantage of memory specifically allocated for use by graphics processor(s), such as memory on a graphics board including graphics processor(s). Program instructions 525 may also be configured to render images and present them on one or more displays as the output of an operation and/or to store image data in memory 520 and/or an external storage device(s), in various embodiments.

System memory 520 may be configured to store program instructions and/or data accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a multimedia player, rendering module(s), event interaction module, and/or integration module are shown stored within system memory 520 as program instructions 525 and data storage 535, respectively. In other embodiments, program instructions and/or data may be received, sent or stored upon different types of computer-accessible media or on similar media separate from system memory 520 or computer system 500. Generally speaking, a computer-accessible medium may include storage media or memory media such as magnetic or optical media, e.g., disk or CD/DVD-ROM coupled to computer system 500 via I/O interface 530. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 540.

In one embodiment, I/O interface 530 may be configured to coordinate I/O traffic between a processor 510, system memory 520, and any peripheral devices in the device, including network interface 540 or other peripheral interfaces. In some embodiments, I/O interface 530 may perform any necessary protocol, timing or other data transformations to convert data signals from one component (e.g., system memory 520) into a format suitable for use by another component (e.g., a processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. In addition, in some embodiments some or all of the functionality of I/O interface 530, such as an interface to system memory 520, may be incorporated directly into processor 510.

Network interface 540 may be configured to allow data to be exchanged between computer system 500 and other devices attached to a network, such as other computer systems, or between nodes of computer system 500. In various embodiments, network interface 540 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Hardware resource(s) 550 may, in some embodiments, support one or more display terminals, keyboards, keypads, touchpads, scanning devices, voice or optical recognition devices, or any other devices suitable for entering or retrieving data by one or more computer system 500. Multiple input/output devices may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

As shown in FIG. 5, memory 520 may include program instructions 525, configured to implement embodiments as described herein, and data storage 535, comprising various data accessible by program instructions 525. In one embodiment, program instructions 525 may include software elements of embodiments as illustrated in the above Figures. Data storage 535 may include data that may be used in embodiments. In other embodiments, other or different software elements and data may be included.

Those skilled in the art will appreciate that computer system 500 is merely illustrative and is not intended to limit the scope of a rendering module, event interaction module, and integration module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, smart phone, tablet computing device, network device, internet appliance, PDA, wireless phones, pagers, a consumer device, video game console, handheld video game device, application server, storage device, a peripheral device such as a switch, modem, router, or in general any type of computing or electronic device. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present disclosure may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the disclosure embrace all such modifications and changes and, accordingly, the above description to be regarded in an illustrative rather than a restrictive sense.

What is claimed is:

1. A method, comprising:
receiving a multimedia presentation that includes that includes two-dimensional (2D) content and three-dimensional (3D) content integrated into a common rendering framework and a common event model;
rendering the 2D and 3D content based on a specification of one or more rendering effects to be applied to both the 2D and the 3D content according to the common rendering framework; and
in response to an event pertaining to the 2D and 3D content, applying an effect to the 2D and 3D content according to the common event model.

2. The method of claim 1, further comprising generating a data structure that includes a plurality of non-graphical objects configured to direct said rendering.

3. The method of claim 1, further comprising generating a data structure that includes a plurality of graphical objects, wherein said rendering includes rendering the 2D and 3D content into the plurality of graphical objects.

4. The method of claim 1, wherein the event is a content-generated event, further comprising applying another effect to content other than 2D and 3D content according to the common event model.

5. The method of claim 1, wherein the rendering effects include blending, filtering, or rotating.

6. The method of claim 1, wherein said rendering comprises a plurality of non-graphical objects of a data structure directing said rendering the 2D and 3D content into a plurality of graphical objects of another data structure.

7. The method of claim 6, wherein said applying includes:
mapping the effect from at least one of the plurality of graphical objects in the another data structure to a corresponding at least one of the plurality of non-graphical objects in the data structure;
updating the corresponding at least one of the plurality of non-graphical objects in the data structure based on the effect; and
rendering the 2D and 3D content again to update the plurality of graphical objects based on the updated corresponding at least one of the plurality of non-graphical objects.

8. The method of claim 6, wherein each of the plurality of non-graphical objects is associated with a corresponding one of the plurality of graphical objects without being associated with others of the plurality of graphical objects.

9. A method, comprising:
receiving two-dimensional (2D) content;
receiving three-dimensional (3D) content;
integrating the 2D content and the 3D content into a common rendering framework and common event model, wherein said integrating includes:
receiving a specification of one or more rendering effects to be applied to both the 2D and the 3D content, and
receiving a specification of one or more event effects to the 2D and the 3D content; and
creating a multimedia presentation that includes the 2D and the 3D content integrated into the common rendering framework and common event model.

10. The method of claim 9, wherein the specification of one or more rendering effects to be applied to both the 2D and the 3D content allows for the 2D and 3D content to be rendered into a single data structure during playback of the multimedia presentation.

11. The method of claim 9, wherein the common rendering framework and common event model enables a data structure that includes a plurality of non-graphical objects to direct rendering of the 2D and 3D content according to the specified rendering effects into another data structure that includes a plurality of graphical objects.

12. The method of claim 9, wherein the specification of one or more event effects to the 2D and the 3D content allows for applying the one or more event effects to the 2D and 3D content in response to an event pertaining to the 2D and 3D content received during playback of the multimedia presentation.

13. The method of claim 12, wherein the common rendering framework and common event model enables a data structure that includes a plurality of non-graphical objects to direct rendering of the 2D and 3D content according to the specified rendering effects into another data structure that includes a plurality of graphical objects, and wherein said applying the one or more event effects during playback of the multimedia presentation includes:
mapping the one or more event effects from at least one of the plurality of graphical objects in the another data structure to a corresponding at least one of the plurality of non-graphical objects in the data structure;
updating the corresponding at least one of the plurality of non-graphical objects in the data structure based on the one or more event effects; and
rendering the 2D and 3D content again to update the plurality of graphical objects based on the updated corresponding at least one of the plurality of non-graphical objects.

14. A non-transitory computer-readable storage medium storing program instructions, wherein the program instructions are computer-executable to implement:
receiving a multimedia presentation that includes that includes two-dimensional (2D) content and three-dimensional (3D) content integrated into a common rendering framework and a common event model;
rendering the 2D and 3D content based on a specification of one or more rendering effects to be applied to both the 2D and the 3D content according to the common rendering framework; and
in response to an event pertaining to the 2D and 3D content, applying an effect to the 2D and 3D content according to the common event model.

15. The non-transitory computer-readable storage medium of claim 14, wherein the program instructions are further computer-executable to implement: generating a data structure that includes a plurality of graphical objects, wherein said rendering includes rendering the 2D and 3D content into the plurality of graphical objects.

16. The non-transitory computer-readable storage medium of claim 14, wherein said rendering comprises a plurality of non-graphical objects of a data structure directing said rendering the 2D and 3D content into a plurality of graphical objects of another data structure.

17. The non-transitory computer-readable storage medium of claim 14, wherein said applying includes:
mapping the effect from at least one of the plurality of graphical objects in the another data structure to a corresponding at least one of the plurality of non-graphical objects in the data structure;
updating the corresponding at least one of the plurality of non-graphical objects in the data structure based on the effect; and
rendering the 2D and 3D content again to update the plurality of graphical objects based on the updated corresponding at least one of the plurality of non-graphical objects.

18. A non-transitory computer-readable storage medium storing program instructions, wherein the program instructions are computer-executable to implement:
receiving two-dimensional (2D) content;
receiving three-dimensional (3D) content;
integrating the 2D content and the 3D content into a common rendering framework and common event model, wherein said integrating includes:
receiving a specification of one or more rendering effects to be applied to both the 2D and the 3D content, and
receiving a specification of one or more event effects to the 2D and the 3D content; and
creating a multimedia presentation that includes the 2D and the 3D content integrated into the common rendering framework and common event model.

19. The non-transitory computer-readable storage medium of claim 18, wherein the specification of one or more rendering effects to be applied to both the 2D and the 3D content allows for the 2D and 3D content to be rendered into a single data structure during playback of the multimedia presentation.

20. The non-transitory computer-readable storage medium of claim 18, wherein the common rendering framework and common event model enables a data structure that includes a plurality of non-graphical objects to direct rendering of the 2D and 3D content according to the specified rendering effects into another data structure that includes a plurality of graphical objects.

21. The non-transitory computer-readable storage medium of claim 18, wherein the specification of one or more event effects to the 2D and the 3D content allows for applying the one or more event effects to the 2D and 3D content in response to an event input pertaining to the 2D and 3D content received during playback of the multimedia presentation.

22. The non-transitory computer-readable storage medium of claim 21, wherein the common rendering framework and common event model enables a data structure that includes a plurality of non-graphical objects to direct rendering of the 2D and 3D content according to the specified rendering effects into another data structure that includes a plurality of graphical objects, and wherein said applying the one or more event effects during playback of the multimedia presentation includes:
mapping the one or more event effects from at least one of the plurality of graphical objects in the another data structure to a corresponding at least one of the plurality of non-graphical objects in the data structure;
updating the corresponding at least one of the plurality of non-graphical objects in the data structure based on the one or more event effects; and
rendering the 2D and 3D content again to update the plurality of graphical objects based on the updated corresponding at least one of the plurality of non-graphical objects.
